(19) United States
(12) Patent Application Publication
(10) Pub. No.: US 2011/0145314 A1
(43) Pub. Date: Jun. 16, 2011

(54) Communication Architecture for Devices Without Access to a Centralized Server

(75) Inventors: Nicholas W. Knize, Rockwall, TX (US); Roberto Reta, Richardson, TX (US); Larry J. Johnson, Sachse, TX (US)

(73) Assignee: Raytheon Company, Waltham, MA (US)

(21) Appl. No.: 12/636,148

(22) Filed: Dec. 11, 2009

(51) Int. Cl. G06F 15/16; G06F 15/173; G06F 17/00

(52) U.S. Cl. 709/203; 709/223; 707/620; 707/E17.005; 707/E17.032

(57) ABSTRACT

According to an embodiment, a mobile communication device comprises a client and a server. The client is operable to directly request information from another communication device when access to a centralized server is unavailable. The direct request bypasses the centralized server and passes through a wireless communication channel. The server is operable to directly provide information to another communication device in response to a request from the other communication device.

The direct providing of information bypasses the centralized server and passes through a wireless communication channel. The mobile communication device is further operable to send requests to the centralized server when the centralized server is available.

### TECHNICAL FIELD

The present disclosure relates generally to a communication architecture, and more particularly to a communication architecture for devices without access to a centralized server.

### BACKGROUND

A communication architecture is a structure that facilitates communication between a number of communication devices. A client-server architecture is a type of communication architecture in which a client application makes a service request to a separate application known as a server application.

### SUMMARY OF EXAMPLE EMBODIMENTS

According to an embodiment, a mobile communication device comprises a client and a server. The client is operable to directly request information from another communication device when access to a centralized server is unavailable. The direct request bypasses the centralized server and passes through a wireless communication channel. The server is operable to directly provide information to another communication device in response to a request from the other communication device. The direct providing of information bypasses the centralized server and passes through a wireless communication channel. The mobile communication device is further operable to send requests to the centralized server when the centralized server is available.

Certain embodiments of the present invention may provide various technical advantages. In some embodiments, one or more communication devices may be able to communicate information in a more efficient manner than allowed by communication through a centralized server. In other embodiments, if one or more of the communication devices is unable to communicate with a centralized server, the communication devices may be able to directly communicate with other communication devices. In other embodiments, a communication device that is unable to communicate directly with a centralized server may be able to communicate with the centralized server by using another communication device as a proxy.

Although specific advantages have been enumerated above, various embodiments may include all, some, or none of the enumerated advantages. Additionally, other technical advantages may become readily apparent to one of ordinary skill in the art after review of the following figures and description.

### BRIEF DESCRIPTION OF THE DRAWINGS

For a more complete understanding of certain embodiments of the present invention and features and advantages thereof, reference is now made to the following description taken in conjunction with the accompanying drawings, in which:

FIG. 1 illustrates a system for communication between two devices without access to a centralized server;

FIG. 2 illustrates the system of FIG. 1 with one device communicating with the centralized server on behalf of another device; and

FIG. 3 illustrates further details of a device, which may be utilized according to certain embodiments.

### DETAILED DESCRIPTION

It should be understood at the outset that, although example implementations of embodiments of the invention are illustrated below, the present invention may be implemented using any number of techniques, whether currently known or not. The present invention should in no way be limited to the example implementations, drawings, and techniques illustrated below. Additionally, the drawings are not necessarily drawn to scale.

A communication architecture provides the ability for two or more communication devices to share information between each other. Typically, two or more communication devices communicate via a centralized server. However, in certain situations, it may be desirable for two or more communication devices to communicate directly. For example, one or more communication devices may desire to communicate information in a more efficient manner than allowed by communication through a centralized server. If the devices must communicate through a centralized server, the desired information must pass through the centralized server before arriving at its intended destination. In certain situations, communication devices may desire to communicate without having to wait for the centralized server to process the information. As another example, if one or more of the communication devices is unable to communicate with a centralized server, the communication devices may desire direct communication with other communication devices. Accordingly, the teachings of some embodiments may allow users of communication devices to communicate without access to a centralized server.

In some embodiments, two or more communication devices may communicate with each other without accessing a centralized server. In other embodiments, a communication device may communicate with a centralized server on behalf of another communication device that is unable to connect with the centralized server in order to send or receive data from the centralized server. In further embodiments, a communication device may maintain a local database from which it can access information when the communication device is unable to communicate with a centralized database.

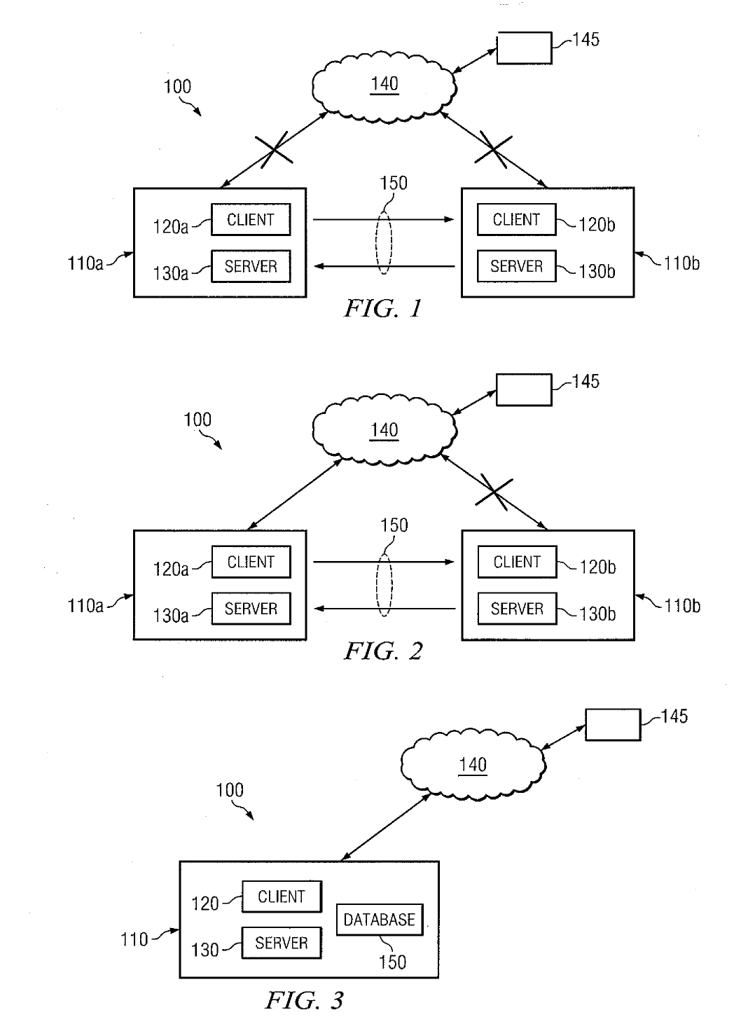

FIG. 1 illustrates a system 100 for communication between two devices without access to a centralized server. Communication system 100 generally includes two communication devices 110, with each communication device coupled to both a client 120 and a server 130. In this particular embodiment, communication devices 110 send and receive communications 150 between each other without access to a communication network 140 that provide s access to a centralized server 145. In particular embodiments, the centralized server 145 may provide information that is traditionally shared between users of the devices. As one example, in a reconnaissance type scenario, a particular user, for example, of device 110a may observe an event and transmit notes, pictures, voice, video, and other types of information to the centralized server 145 using the communication network 140. In typical scenarios, a user of device 110b could subsequently receive such information from the centralized server 145 (e.g., by accessing the communication network 140) and use such information to discover information about a particular area.

However, embodiments recognize that in certain scenarios, the communication network 140 may not be available for whatever reason. Accordingly, devices 110a, 110b may communicate directly with one another without using the communication network 140 by acting as both a client and a server. That is, during the transmission of certain communications 150, the client 120a on communication device 110a communicates with server 130b on communication device 110b. During the transmission of certain other communications 150, client 120b on communication device 110b communicates with server 130a on communication device 110a. Thus, system 100 allows two communication devices 110 to transmit communications 150 between each other without access to the communication network 140 and the centralized server 145.

As an example, a particular piece of data that may conventionally be sent to server 145 can be locally stored on device 110a and served to client 120b of device 110b using server 130a. Although access to a particular communication network 140 is not available, communications 150 may take place using standard communications techniques, which may comprise all or a portion of a public switched telephone network (PSTN); a public or private data network; a local area network (LAN); a metropolitan area network (MAN); a wide area network (WAN); a global computer network such as the Internet; a wireline or wireless network; a local, regional, or global communication network; a satellite network; an enterprise intranet; other suitable communication links; or any combination of the preceding. As an example, in one embodiment, the communications 150 directly between devices 110a and 110b may take place over a public or private mobile communication network. Additionally, in particular embodiments, the communication 50 between the devices may only involve communication components of the devices themselves (e.g., transmit and receive modules) and no mobile communication network whatsoever. For example, where the devices 110 are mobile devices, the communication 50 may simply using only the transmit and receive functionality of the devices 110 a “networkless” connection.

With the networkless connection, an ad-hoc set of communication devices 110 can relay messages back and forth to one another. In one embodiment as will be discussed below with reference to FIG. 2, a message can reach another device 110 on the networkless connection by hopping to an intermediate device or devices and then being relayed to the desired device. Such an ad-hoc networkless connection may be particularly advantageous in settings where there is no network because, for example, there is no power for the network. In such scenarios, each particular device can serve as a proxy or router messages that they are forwarding on.

As an example of the above, two military troops located in a combat zone may desire to share data between each other. However, if the military troops are located in a remote region, they may not be able to achieve communication with network 140 in order to communicate with the centralized server 145. Each troop's communication device 110 may be able to communicate with the other directly (either using another network or networklessly communicating) in order to share data without having access to the centralized server 145. For example, the client 120 on the first troop's communication device 110 may request data from the server 130 on the second troop's communication device 110. In response, the server 130 on the second troop's communication device may send a data response to the client on the firs troop's communication device 110.

As another example, a particular message may need to be sent between devices 110; however, there is no network access. Accordingly, each device may be relay messages between each other only using the transmit and receive functionality for communication between the different devices. For example, a first device may receive the message and then relay the message to a second device, which may receive the message and further relay it to a third device.

Each communication device 110 may be an entity, such as a client, subscriber, end-user, or customer that seeks to initiate a communication 150 in communication system 100. Communication devices 110 may operate to use any suitable device for communications in communication system 100. Communication devices 110 may further represent a communications interface for an end-user of communication system 100. Each communication device 110 may be a cellular or other wireless telephone, an electronic notebook, a computer, a personal digital assistant (PDA), or any other device, component, or object capable of initiating a data exchange facilitated by communication system 100. Communication devices 110 may be portable. Two non-limiting examples of communication devices 110, according to a particular embodiment, are Google's G1 mobile phone running on the Android platform and Apple's Iphone.

In some embodiments, the position of the communication devices 110 may be determined using a Location Based Services (LBS) system. An LBS system may be any system suitable for locating the latitude, longitude, and/or elevation coordinates of the communication devices 110. For example, an LBS system may use a satellite system such as a Global Positioning System (GPS) to locate the communication devices 110. As another example, an LBS system may use multilateration techniques based on the signals sent and/or received by the communication devices 110 such as Time Difference Of Arrival (TDOA) techniques or Enhanced Observed Time Difference (E-OTD) techniques. In further embodiments, the devices 110 may use a combination of techniques to determine a location, for example, Assisted GPS.

In particular embodiments, positional information may be communicated over communication 150. Additionally, in certain embodiments, communication devices 110 may be able to broadcast their position to each other in order for the users of communication devices 110 to selectively communicate with other communication devices 110 based on their location information. As a one non-limiting example, a user of device 110a may desire information about a particular area. Accordingly, the device 110a may broadcast an inquiry to other devices 110, inquiring as to whether any of such devices have information about the particular area. Such an inquiry could normally be sent to server 145; however, as indicated above access to server 145 may not be available. In response to the broadcasted inquiry, the device 110b could send device 110a information concerning the area using server 130b of device 110b. The example can happen without access to server 145.

Thus, with reference to the above discussion, direct communication between two devices may be particularly useful in particular embodiments, for example, when access the server 145 is no longer available.

Clients 120 are generally any applications or systems that access a remote service on another computer system, which may be one of the servers 130 or server 145 in particular embodiments. Clients 120 and servers 130 may be located communication devices 110. In some embodiments, client 120a on communication device 110a sends a data request to server 130b on communication device 110b. In some embodiments, server 130b may send a data response to client 120b in response to a data request. Thus, a client 120 can send data requests to a server 130, and, in response, the server 130 may accept the request, process it, and return the requested data to the client 120.

Communications 150 may transmit data requests or responses made by clients 120 and servers 130 on communication devices 110. The types of data are virtually limitless, and can include any type of numeric, voice, video, audio-visual, or script data, or any type of source or object code, or any other suitable information in any appropriate format that may be communicated from one point to another.

As will be described further below, the data shared between two devices are not necessarily limited to data actually gathered by one device and sent to the other device. For example, a third device (not shown) may have directly shared information with device 110b. Device 110b may in turn, directly share such information with device 110a. Thus, in particular embodiments, the storage capabilities (which may be large) on the devices 110 may be viewed as a backup to some or all portions of the server 145—a “lite” version of information accessible by the server 145.

In particular, embodiments, the network 140, itself, similar to the communications 150 may represent any suitable combination and arrangement of components supporting communications between communication devices 110 and the centralized server 145. For example, network 140 may include local area networks (LANs), wide area networks (WANs), elements of the public switched telephone network (PSTN), portions of the Internet, and components in other suitable communications networks. In some instances, communication devices 110 may be unable to communicate with a centralized server through network 140. In other instances, communication devices 110 may desire to communicate directly, without accessing the centralized server, in order to transmit communications 150 more efficiently.

A component described in FIG. 1 may include an interface, logic, memory, and/or other suitable element used to carry out the above-described functions. An interface receives input, sends output, processes the input and/or output, and/or performs other suitable operation. An interface may comprise hardware and/or software.

Logic performs the operations of the component, for example, executes instructions to generate output from input. Logic may include hardware, software, and/or other logic. Logic may be encoded in one or more tangible media and may perform operations when executed by a computer. Certain logic, such as a processor, may manage the operation of a component. Examples of a processor include one or more computers, one or more microprocessors, one or more applications, and/or other logic.

In particular embodiments, the operations of the embodiments may be performed by one or more computer readable media encoded with a computer program, software, computer executable instructions, and/or instructions capable of being executed by a computer. In particular embodiments, the operations of the embodiments may be performed by one or more computer readable media storing, embodied with, and/or encoded with a computer program and/or having a stored and/or an encoded computer program.

A memory stores information. A memory may comprise one or more tangible, computer-readable, and/or computer-executable storage medium. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

The components of the systems may be integrated or separated. Moreover, the operations of the systems may be performed by more, fewer, or other components. Additionally, operations of the systems may be performed using any suitable logic comprising software, hardware, and/or other logic. As used in this document, “each” refers to each member of a set or each member of a subset of a set.

FIG. 2 illustrates the system 100 of FIG. 1 with one device 110a communicating with the centralized server 145 on behalf of another device 110b. The discussion above concerning system 100 of FIG. 1 is applicable to FIG. 2 except that device 110a now has access to the communication network 140 and centralized server 145. In scenarios such as this, the system 100 allows device 110a to send requests to centralized server 145 on behalf of another device, for example device 110b.

In operation, device 110b may directly broadcast a request to other devices, including device 110a, seeking information and/or content. In response, device 110a or other devices can respond that it currently has a connection to the communication network 140 and/or server 145. If more than one device has a connection, any of a variety of conflict resolution methodologies can be utilized. Ultimately, if device 110a is chosen, device 110a will serve as a proxy in communicating device 110b's request to the server 145 or, in particular embodiments, another communication device 110 (a third communication device). Then, when device 110a receives a response, it will communicate that response to device 110b. To facilitate this operation and to account for the possibility of intermittent connections between device 110a and server 145 (or the third communication device) or device 110a and device 110b, device 110a can keep a cache of the response from server 145 (or the third communication device) for delivery whenever device 110b is able to communicate with device 110a.

Although a single “hop” of communication is shown, it should be understood that multiple hops of communications can be utilized. As just one example, communication device 110a may not be able to communication with a third device (e.g., they may be on separate communication networks). However, communication device 110b may be able to communicate directly with this third device. Accordingly, the third device may broadcast a request, which may be received by device 110b and then relayed from device 110b to device 110a. Ultimately, device 110a makes the request of the server and sends the response back to the third device by way of device 110b. Similar to the above, caching may be utilized at device 110a and device 110b.

FIG. 3 illustrates further details of a device 110, which may be utilized according to certain embodiments. The discussion above concerning FIG. 1 is equally applicable to FIG. 3, except that further details are provided concerning how device 110 may interoperate with storage of data. In particular embodiments, the server 130 on device 110 may operate as an application server not only to the device 110, itself, but also for other devices which may seek content from device 100. Accordingly, the device 110 may operate as a “lite” version of information available at the server 145. For example, as described above, the server may serve information from a data information base (DIB). The device 110 may synchronize, as appropriate, with information from the DIB of server 145 to operate as a “lite” DIB stored on database 150 of the device 110.

In operation, the device 110 may obtain information from server 145 when access to a network 140 is available. Then, when access to a network 140 is not available (e.g., the device 110 is out of range of the communication network 140 or the server 145 is down), the “lite” DIB on the database 150 may be utilized. Additionally, as referenced above, in certain embodiments, device may serve up information to other device, for example, using this “lite” DIB on the database 150.

Any of a variety of synchronization techniques may be utilized to synchronize the DIB of server 145 and the “lite” DIB on the database 150. Additionally, although the term “lite” is used, the DIB on the database 150 may be copy of the entirety of the DIB accessed by server 145 in certain embodiments.

With reference to FIGS. 2 and 3, the update of the “lite” DIB may hinge on whether the device 110a is serving as a proxy for more than one other device. As one example, device 110b may request a particular item that is sent to server 145 through device 110a; however, device 110a may update a local database with additional information that may be pertinent to device 110b in future requests.

With reference to the discussion above, various embodiments compensate for intermittent access that may occur with respect to a particular. In such compensation, certain embodiments allow sharing information directly between devices, other embodiments allow relaying requests, and other embodiments allow a storing of information locally using synchronization where necessary.

Although several embodiments have been illustrated and described in detail, it will be recognized that substitutions and alterations are possible without departing from the spirit and scope of the present invention, as defined by the appended claims.

To aid the Patent Office, and any readers of any patent issued on this application in interpreting the claims appended hereto, applicants wish to note that they do not intend any of the appended claims to invoke 6 of 35 U.S.C. §112 as it exists on the date of filing hereof unless the words “means for” or “step for” are explicitly used in the particular claim.

What is claimed is:

1. A mobile communication device comprising:
a client operable to directly request information from another mobile communication device when access to a centralized server is unavailable, the direct request bypassing the centralized server and passing through a wireless communication channel;
a server operable to directly provide information to the other mobile communication device in response to a request from the other mobile communication device, the direct providing of information bypassing the centralized server and passing through a wireless communication channel; and
wherein the mobile communication device is operable to send requests to the centralized server when the centralized server is available.

2. The mobile communication device of claim 1, wherein the communication between the mobile communication device and the other mobile communication device uses no mobile communication network and only communication equipment on the mobile communication device and the other mobile communication device.

3. The mobile communication device of claim 1, further comprising:
a software module operable to serve as a proxy for the other mobile communication device in relaying requests from the other communication device to the centralized server or a third mobile communication device and relaying responses from the third mobile communication device or centralized server to the other mobile communication device.

4. A communication device comprising:
a client operable to directly request information from another communication device, the direct request bypassing a centralized server;
a server operable to directly provide information to another communication device in response to a request from the other communication device, the direct providing of information bypassing the centralized server.

5. The communication device of claim 4, wherein:
the communication device is a mobile device.

6. The communication device of claim 4, wherein:
the communication between the communication device and the other communication device is networkless.

7. The communication device of claim 4, wherein:
one or both of the server and client are further operable to directly communicate with the other communication device when access to the centralized server is unavailable, the direct communication bypassing the centralized server.

8. The communication device of claim 4, further comprising:
a software module operable to serve as a proxy for the other communication device in relaying requests from the other communication device to the centralized server or a third communication device and relaying responses from the third communication device or the centralized server to the other communication device.

9. The communication device of claim 8, wherein: further comprising:
the software module comprises one or both of the server and the client.

10. The communication device of claim 8, wherein:
the software module caches the responses from the third communication device or the centralized server and make the responses available to the other device when the other device can communication with the communication device.

11. The communication device of claim 4, further comprising:
a software module operable to receive a request from a third communication device that is not in communication with the other communication device and relay the request from the third communication device to the other communication device.

12. The communication device of claim 4, further comprising:
a database, the database providing information to the device when access to the centralized server is unavailable.

13. The system of claim 12, wherein:
the database synchronizes with information available at the centralized server when access to the centralized server is unavailable.

14. The system of claim 12, wherein:
the synchronization is based at least in part on requests received at the communication device from other communication devices.

15. A method of communicating with another communication device, the method comprising:
at a communication device, directly receiving a request for information from another communication device, the direct request bypassing a centralized server; and
at the communication device, directly providing information to another communication device in response to a request from the other communication device, the direct providing of information bypassing the centralized server.

16. The method of claim 15, wherein:
the communication device is a mobile device.

17. The method of claim 15, wherein:
the communication between the communication device and the other communication device is networkless.

18. The method of claim 15, further comprising:
directly communicating with the other communication device when access to the centralized server is unavailable, the direct communication bypassing the centralized server.

19. The method of claim 15, further comprising:
at the communication device, relaying requests from the other communication device to the centralized server or a third communication device; and
at the communication device, relaying responses from the centralized server or the third communication device to the other communication device.

20. The method of claim 19, further comprising:
at the communication device, caching responses from the centralized server or the third communication device; and
at the communication device, making the responses available to the other device when the other communication device can communication with the communication device.

21. The method of claim 15, further comprising:
at the communication device, receiving a request from a third communication device that is not in communication with the other communication device;
at the communication device, relaying the request from the third communication device to the other communication device.

22. The method of claim 15, further comprising:
at the communication device, accessing local database when a database when access to the centralized server is unavailable.

23. The method of claim 15, further comprising:
synchronizing information available at the centralized server with the local database when access to the centralized server is unavailable.

24. The method of claim 12, wherein:
the synchronization is based at least in part on requests received at the communication device from other communication devices.
